(19) United States
(12) Patent Application Publication
(10) Pub. No.: US 2024/0332498 A1
(43) Pub. Date: Oct. 3, 2024

(54) METHOD FOR MANUFACTURING SECONDARY BATTERY ELECTRODE SLURRY COMPOSITION, AND METHODS FOR MANUFACTURING SECONDARY BATTERY ELECTRODE AND SECONDARY BATTERY

(71) Applicant: TOAGOSEI CO., LTD., Tokyo (JP)

(72) Inventors: Ayano SHIMURA, Nagoya-shi (JP); Masaki SHIMADA, Nagoya-shi (JP); Naohiko SAITO, Nagoya-shi (JP)

(73) Assignee: TOAGOSEI CO., LTD., Tokyo (JP)

(21) Appl. No.: 18/293,111

(22) PCT Filed: Jul. 21, 2022
(86) PCT No.: PCT/JP2022/028302

§ 371 Date: Jan. 29, 2024

(30) Foreign Application Priority Data
Jul. 29, 2021 (JP) 2021-124499

(51) Int. Cl. H01M 4/36; H01M 4/04; H01M 4/139; H01M 4/62

(52) U.S. Cl. CPC H01M 4/364; H01M 4/0404; H01M 4/139; H01M 4/622

(57) ABSTRACT

A method for manufacturing a secondary battery electrode slurry composition, the method includes kneading a composition having a solids concentration of from 60 mass % to 80 mass % containing an active material, a thickener and water to obtain a first kneaded product; adding a hydrophilic binder (different from the thickener) and water to the first kneaded product, and kneading the same to obtain a second kneaded product; and adjusting the solids concentration of the second kneaded product to from 40 mass % to 60 mass %.

### TECHNICAL FIELD

The present invention relates to a method for manufacturing a secondary battery electrode slurry composition, and to methods for manufacturing a secondary battery electrode and a secondary battery.

### BACKGROUND ART

Various power storage devices such as nickel-hydrogen secondary batteries, lithium-ion secondary batteries and electric double-layer capacitors are in practical use as secondary batteries. To prepare electrodes for use in such secondary batteries, a composition containing an active material, a binder and the like for forming an electrode mixture layer is coated and dried and the like on a capacitor. In the case of lithium-ion secondary batteries for example, water-based binders containing styrene-butadiene rubber (SBR) latex and carboxymethyl cellulose (CMC) are used as binders in negative electrode slurry compositions. On the other hand, N-methyl-2-pyrrolidone (NMP) solutions of polyvinylidene fluoride (PVDF) are widely used as binders in positive electrode mixture layers.

In general, secondary battery electrodes are obtained by coating and drying a secondary battery electrode slurry composition (hereunder sometimes called an “electrode slurry”) containing an active material, a thickener and a binder onto the surface of an electrode current collector. A useful way of increasing a drying efficiency of the electrode slurry in this case and improving electrode productivity is to increase solids concentration of the secondary battery electrode slurry composition, but this makes it difficult to ensure good coating properties.

As a method for manufacturing a secondary battery electrode slurry composition with a high solids concentration, for example Patent Literature 1 describes a method for manufacturing a non-aqueous electrolyte secondary battery, the method including a step of kneading a negative electrode active material with CMC and water to produce a primary kneaded product (solids concentration of 70 mass % or less), further diluting this primary kneaded product by addition of water, and then adding a binder to produce a negative electrode paste for manufacturing a negative electrode.

Patent Literature 1 discloses specifically a method for manufacturing a negative electrode slurry composition (hereunder sometimes called a “negative electrode slurry”) using CMC as a thickener and SBR as a water-based binder, and states that it is possible to ensure peel strength in a negative electrode while using highly viscous CMC to manufacture a non-aqueous electrolyte secondary battery having excellent output characteristics and cycle characteristics.

Meanwhile, Patent Literature 2 describes a method for manufacturing a paste for manufacturing a negative electrode, the method including a step (A) of mixing a negative electrode active material with a first thickener to prepare a mixture (MI) containing at least the negative electrode active material and the first thickener, a step (B) of adding and wet mixing one or two or more liquid components selected from aqueous emulsion solutions containing aqueous media and water-based binders into the mixture (MI) to prepare a paste precursor, and a step (C) of further adding and wet mixing the liquid component into the paste precursor to prepare a paste for manufacturing a negative electrode. The step (B) includes at least a step (B1) of blending the liquid component with the mixture (M1) to obtain a mixture (M2), a step (B2) of mixing a second thickener and the liquid component to the mixture (M2) to obtain a mixture (M3), and a step (B3) of kneading the mixture (M3) to prepare the paste precursor, in that order.

Patent Literature 2 discloses specifically a method for using CMC as a thickener and SBR as a water-based binder to manufacture a negative electrode slurry composition (negative electrode slurry) with a solids concentration of 51 mass %, and states that it is possible to stably obtain a negative electrode for a battery having excellent adhesiveness between a collector layer and a negative electrode active material layer.

Furthermore, Patent Literature 3 describes a method for using a multi-stage process that includes at least a first kneading step (solids concentration 68 mass % to 79 mass %) in which a plurality of powder materials including at least a negative electrode active material and a thickener are dry mixed in a powder state, and an aqueous solution containing an aqueous medium and a water-based binder is then added and wet mixed, followed by a second kneading step (solids concentration 59 mass % to 66 mass %).

Patent Literature 3 discloses specifically a method for using CMC as a thickener and SBR as a water-based binder to manufacture a negative electrode slurry composition (negative electrode slurry) having a solids concentration of 59 to 66 mass %, and states that it is possible to control the viscosity of the negative electrode slurry within a fixed range and stably obtain a secondary battery negative electrode having excellent adhesiveness between a negative electrode active material layer and a collector layer.

### CITATION LIST

### Patent Literature

[Patent Literature 1] Japanese Patent Application Publication No. 2014-11075

[Patent Literature 2] Japanese Patent Application Publication No. 2019-164887

[Patent Literature 3] WO 2019/107054

### SUMMARY OF INVENTION

### Technical Problem

In recent years, along with improvements in performance and productivity of secondary batteries, there have been demands for further improvements in coating properties of secondary battery electrode slurry compositions (electrode slurries), and in adhesiveness (hereunder sometimes called “peel strength”) between an electrode active material layer and a collector layer.

Although the manufacturing methods described in Patent Literature 1 and 2 all may be able to confer good peel strength, there is no indication of a relationship between the manufacturing methods themselves and viscosity or coating properties of the electrode slurries. However, the manufacturing method described in Patent Literature 3 discloses that it is possible to confer good coating properties and peel strength.

However, there has been a problem in that when a secondary battery electrode slurry composition is manufactured using a water-based binder that is more hydrophilic than SBR in the manufacturing methods described in Patent Literature 1 to 3, the composition is likely to be more viscous, hence the electrode slurry may not provide both good coating properties and peel strength.

In light of these circumstances, it is an object of the present invention to provide a method for manufacturing a secondary battery electrode slurry composition, wherein when solids concentration of the composition is higher than in the prior art, it is still possible to ensure the coating properties by reducing the viscosity of the composition, and obtain a secondary battery electrode having excellent peel strength (adhesiveness). A method for manufacturing a secondary battery electrode and a method for manufacturing a secondary battery using this slurry composition are also provided.

### Solution to Technical Problem

The inventors have perfected the present invention as a result of diligent research aimed at solving these problems after discovering that coating properties of the slurry composition could be ensured and a secondary battery electrode having excellent peel strength (adhesiveness) could be obtained by adopting a method for manufacturing a secondary battery electrode slurry composition, the method including a step of kneading a first composition containing an active material, a thickener and water and having a solids concentration within a specific range to obtain a first kneaded product, a step of adding a hydrophilic binder and water to this first kneaded product and kneading to obtain a second kneaded product, and a step of adjusting solids concentration of this second kneaded product to within a specific range.

The present invention is as follows.

[1] A method for manufacturing a secondary battery electrode slurry composition, the method comprising:
a step A of kneading a composition having a solids concentration of equal to or not less than 60 mass % and equal to or not more than 80 mass % containing an active material, a thickener and water to obtain a first kneaded product;
a step B of adding a hydrophilic binder (different from the thickener) and water to the first kneaded product, and kneading the same to obtain a second kneaded product; and
a step C of adjusting the solids concentration of the second kneaded product to equal to or not less than 40 mass % and equal to or not more than 60 mass %.

[2] The method for manufacturing a secondary battery electrode slurry composition according to [1], wherein the step B includes a step B1 of adding an aqueous solution of the hydrophilic binder to the first kneaded product, and kneading the same to obtain a second kneaded product.

[3] The method for manufacturing a secondary battery electrode slurry composition according to [1], wherein the step B includes a step B2 of adding the hydrophilic binder to the first kneaded product, and kneading the same, and further a step B3 of adding water and kneading the same to obtain a second kneaded product.

[4] The method for manufacturing a secondary battery electrode slurry composition according to any one of [1] to [3], wherein the hydrophilic binder is obtained by polymerizing monomer components including an ethylenically unsaturated carboxylic acid monomer, and the ethylenically unsaturated carboxylic acid monomer constitutes equal to or not less than 50 mass % and equal to or not more than 100 mass % of total monomer components.

[5] The method for manufacturing a secondary battery electrode slurry composition according to any one of [1] to [4], wherein the hydrophilic binder is crosslinked with a crosslinkable monomer, and an amount of the crosslinkable monomer used is equal to or not less than 0.001 mol % and equal to or not more than 2.5 mol % of a total of a non-crosslinkable monomer.

[6] The method for manufacturing a secondary battery electrode slurry composition according to any one of [1] to [5], wherein the hydrophilic binder has a degree of neutralization of equal to or not less than 80 mol % and equal to or not more than 100 mol %.

[7] The method for manufacturing a secondary battery electrode slurry composition according to any one [1] to [6], wherein the thickener contains carboxymethyl cellulose (CMC).

[8] The method for manufacturing a secondary battery electrode slurry composition according to any one of [1] to [7], wherein the step C includes a step of adding styrene-butadiene rubber (SBR) latex.

[9] A method for manufacturing a secondary battery electrode, the method comprising a step of forming on a surface of a collector a mixture layer from a secondary battery electrode slurry composition obtained by a secondary battery electrode slurry composition manufacturing method according to any one of [1] to [8].

[10] A method for manufacturing a secondary battery, the method comprising a step of manufacturing a secondary battery provided with the secondary battery electrode obtained by the manufacturing method according to [9].

### Advantageous Effects of Invention

With the method for manufacturing a secondary battery electrode slurry composition of the present invention, it is possible to obtain a secondary battery electrode with excellent peel strength (adhesiveness) while ensuring the coating properties by reducing the viscosity of the slurry composition even when the solids concentration of the slurry composition is higher than in the past.

### DESCRIPTION OF EMBODIMENTS

The secondary battery electrode slurry composition of the present invention contains a thickener, an active material, a hydrophilic binder and water. This slurry composition is in the form of a slurry that can be coated on a collector. The secondary battery electrode of the present invention is obtained by forming a mixture layer from this composition on the surface of a collector made of copper foil, aluminum foil or the like. A hydrophilic binder is desirable here because the effects of the present invention are particularly great with a secondary battery electrode slurry composition containing a silicon active material as the active material as described below.

The thickener, active material, hydrophilic binder and other components, the method for manufacturing a secondary battery electrode slurry composition, and the method for manufacturing a secondary battery electrode and method for manufacturing a secondary battery using this composition are described in detail below.

In the present Description, “(meth)acrylic)” means acrylic and/or methacrylic, and “(meth)acrylate” means acrylate and/or methacrylate. Furthermore, a “(meth)acryloyl group” means an acryloyl group and/or methacryloyl group.

### 1. Thickener

The thickener is not particularly limited as long as it improves the coating properties of the secondary battery electrode slurry composition (and is different from the hydrophilic binder of the invention).

Examples of the thickener include cellulose-based water-soluble polymers, substituted products comprising cellulose-based water-soluble polymers substituted with carboxymethyl groups, or salts of these (hereunder such substituted products and their salts may be collectively called “CMC”), alginic acid or its salts, and oxidized starch, phosphorylated starch, casein, starch and the like. Of these, CMC is desirable for obtaining an electrode slurry having excellent coating properties when adsorbed on an active material, and for obtaining a secondary battery electrode with excellent peel strength (adhesiveness).

Specific examples of the cellulose-based water-soluble polymers here include alkyl cellulose such as methyl cellulose, methyl ethyl cellulose, ethyl cellulose and microcrystalline cellulose; and hydroxyalkyl cellulose such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose and nonoxynyl hydroxyethyl cellulose and the like.

### 2. Active Material

A positive electrode active material may be a lithium salt of a transition metal oxide, and examples include laminar rock salt-type and spinel-type lithium-containing metal oxides. Specific compounds that are laminar rock salt-type positive electrode active materials include lithium cobaltate, lithium nickelate, and NCM {Li(Niₓ, Co_{y}, Mn_{z}), x+y+z=1} and NCA {Li(Ni_{1-a-b}CoₐAl_{b})}, which are known as ternary systems. Examples of spinel-type positive electrode active materials include lithium manganate and the like. Apart from oxides, phosphate salts, silicate salts, sulfur and the like are also used, and examples of phosphate salts include olivine-type lithium iron phosphate and the like. One such positive electrode active material may be used alone, or two or more may be combined and used as a mixture or composite.

When a positive electrode active material containing a laminar rock salt-type lithium-containing metal oxide is dispersed in water, the dispersion exhibits alkalinity because the lithium ions on the active material surface are exchanged for hydrogen ions in the water. There is thus the risk of corrosion to commonly used positive electrode collector materials such as aluminum foil (Al). In such cases, it is desirable to neutralize the alkali component eluted from the active material by using an unneutralized or partially neutralized main polymer as the hydrophilic binder. Moreover, the amount of the unneutralized or partially neutralized polymer used is preferably such that the amount of unneutralized carboxyl groups in the polymer is equal to or more than the amount of alkali eluted from the active material.

Because all the positive electrode active materials have low electrical conductivity, a conductive aid is normally added and used. Examples of conductive aids include carbon materials such as carbon black, carbon nanotubes, carbon fiber, graphite fine powder, and carbon fiber. Of these, carbon black, carbon nanotubes and carbon fiber are preferable to make it easier to obtain excellent conductivity. As the carbon black, ketjen black and acetylene black are preferable. One of these conductive aids alone or a combination of two or more may be used. To achieve both conductivity and energy density, the amount of the conductive aid used may be from 0.2 to 20 mass parts or from 0.2 to 10 mass parts for example per total 100 mass parts of the active material. A positive electrode active material that has been surface coated with a carbon material having conductivity may also be used

Examples of negative electrode active materials include carbon materials, lithium metal, lithium alloys and metal oxides, and one of these or a combination of two or more may be used. Of these, an active material formed of a carbon material such as natural graphite, artificial graphite, hard carbon or soft carbon (hereunder referred to as a “carbon-based active material”) is preferred, and hard carbon or a graphite such as natural graphite or artificial graphite is more preferred. In the case of graphite, spherical graphite is preferred from the standpoint of battery performance, and the particle size thereof is preferably in the range of from 1 to 20 microns for example, or from 5 to 15 microns for example. To increase the energy density, metals, metal oxides or the like capable of occluding lithium, such as silicon and tin, may also be used as negative electrode active materials. Of these, silicon has a higher capacity than graphite, and an active material formed of a silicon material such as silicon, a silicon alloy or a silicon oxide such as silicon monoxide (SiO) (hereunder referred to as a “silicon-based active material”) may be used. Although these silicon-based active materials have high capacities, however, the volume change accompanying charging and discharging is large. Therefore, they are preferably used in combination with the aforementioned carbon-based active materials. In this case, the electrode material may disintegrate and the cycle characteristics (durability) may decline drastically if the compounded amount of the silicon active material is too high. From this perspective, when a silicon active material is included the amount thereof is preferably not more than 60 mass % or for example not more than 30 mass % of the carbon-based active material.

Because the carbon-based active material itself has good electrical conductivity, it may not be necessary to add a conductive aid. When a conductive aid is added with the aim of further reducing resistance or the like, from the standpoint of energy density the amount thereof is for example not more than 10 mass parts, or for example not more than 5 mass parts per 100 mass parts of the total active material.

### 3. Hydrophilic Binder

The hydrophilic binder used in the present invention is not particularly limited as long as it has a structural unit derived from a hydrophilic vinyl monomer, and this monomer may be any radical polymerizable hydrophilic vinyl monomer without limitations (as long as it is different from the thickening agent).

Furthermore, the hydrophilic binder used in the present invention may be either a crosslinked polymer (hereunder sometimes called “the crosslinked polymer”) or a non-crosslinked polymer (hereunder sometimes called “the non-crosslinked polymer”). The crosslinked polymer and the non-crosslinked polymer may be used independently, or combined. Moreover, one kind alone or two or more kinds of the crosslinked polymer or non-crosslinked polymer may be used.

A hydrophilic vinyl monomer having polar groups such as carboxyl groups, amido groups, amino groups, phosphate groups, sulfonate groups, quaternary ammonium groups or salts of these (including partially or completely neutralized salts) or the like may be used as the hydrophilic vinyl monomer for example.

Of these, a hydrophilic vinyl monomer having carboxyl groups (hereunder also called an “ethylenically unsaturated carboxylic acid monomer”) is desirable for improving adhesiveness on the collector, and also for obtaining an electrode with low resistance and excellent high-rate characteristics due to its excellent ion conductivity and lithium ion desolvation effect.

Examples of the ethylenically unsaturated carboxylic acid monomer include (meth)acrylic acid, itaconic acid, crotonic acid, maleic acid and fumaric acid; (meth)acrylamido alkylcarboxylic acids such as (meth)acrylamidohexanoic acid and (meth)acrylamidododecanoic acid; and carboxyl group-containing ethylenically unsaturated monomers such as monohydroxyethyl succinate (meth)acrylate, ω-carboxycaprolactone mono(meth)acrylate and carboxyethyl(meth)acrylate, and (partially) alkali neutralized products of these, and one of these alone or a combination of two or more may be used. Of these, a compound having acryloyl groups as polymerizable functional groups is preferred because the rapid polymerization speed produces a polymer with a long primary chain length and a hydrophilic binder with good binding strength, and acrylic acid is especially preferred. A polymer with a high carboxyl group content can be obtained by using acrylic acid as an ethylenically saturated carboxylic acid monomer.

A hydrophilic vinyl monomer having amido groups (hereunder also called an “amido group-containing ethylenically unsaturated monomer”) is preferred for obtaining a hydrophilic binder with excellent adhesiveness.

Examples of amido group-containing ethylenically unsaturated monomers include N-alkyl (meth)acrylamide compounds such as isopropyl (meth)acrylamide and t-butyl (meth)acrylamide; N-alkoxyalkyl (meth)acrylamide compounds such as N-n-butoxymethyl (meth)acrylamide and N-isobutoxymethyl (meth)acrylamide; N,N-dialkyl (meth)acrylamide compounds such as dimethyl (meth)acrylamide and diethyl (meth)acrylamide, and cyclic (meth)acrylamide compounds such as N-acryloyl morpholine and the like. One of these alone or a combination of two or more may be used. Of these, N-acryloyl morpholine is preferred for easily obtaining a high-molecular-weight polymer with excellent adhesiveness.

### 3-1. The Crosslinked Polymer

The crosslinked polymer is explained here using an ethylenically unsaturated carboxylic acid monomer as the hydrophilic vinyl monomer.

### Structural Unit Derived From Ethylenically Unsaturated Carboxylic Acid Monomer

The crosslinked polymer contained in the hydrophilic binder may contain a structural unit derived from an ethylenically unsaturated carboxylic acid monomer (hereunder also called “component (a1)”) in the amount of from 50 mass % to 100 mass % of the polymer. When the crosslinked polymer has carboxyl groups due to having this structural unit, not only is adhesiveness on the collector improved, but resistance is low due to the lithium ion desolvation effect and excellent ion conductivity, resulting in an electrode with excellent high-rate characteristics. Because this also confers water swellability, moreover, it is also possible to increase the dispersion stability of the active material and like in the slurry composition. The component (a1) can be introduced into the polymer for example by polymerizing monomers including an ethylenically unsaturated carboxylic acid monomer. It can also be obtained by (co)polymerizing and then hydrolyzing a (meth)acrylic acid ester monomer. Other methods include first polymerizing (meth)acrylamide with (meth)acrylonitrile or the like and then treating this with a strong alkali, or reacting an acid anhydride with a polymer having hydroxyl groups.

Examples of ethylenically unsaturated carboxylic acid monomers include those listed above. Of those, a compound having acryloyl groups as polymerizable functional groups is preferred for obtaining a polymer with a long primary chain length due to the rapid polymerization speed, and for improving the adhesive strength of the hydrophilic binder, and acrylic acid is particularly desirable. A polymer with a high carboxyl group content can be obtained by using acrylic acid as an ethylenically unsaturated carboxylic acid monomer.

The content of the component (a1) in the crosslinked polymer is from 50 mass % to 100 mass % of the total structural units in the crosslinked polymer. If the content of the component (a1) is within this range, it is possible to easily ensure excellent adhesiveness on the collector. A minimum content of at least 50 mass % is desirable for giving the slurry composition good dispersion stability and obtaining greater adhesive strength, and the content may also be at least 60 mass %, or at least 70 mass %, or at least 80 mass %. The maximum content is for example not more than 99.9 mass %, or for example not more than 99.5 mass %, or for example not more than 99 mass %, or for example not more than 98 mass %, or for example not more than 95 mass %, or for example not more than 90 mass %, or for example not more than 80 mass %. The range may be set by appropriately combining these minimum and maximum values, and may be from 50 mass % to 100 mass %, or from 50 mass %, to 99.9 mass %, or from 50 mass % to 99 mass %, or from 50 mass % to 98 mass % for example.

### Other Structural Units

In addition to the component (a1) , the crosslinked polymer may also contain a structural unit (hereunder also called the “component (b1”) derived from an ethylenically unsaturated monomer that is copolymerizable with these. Examples of the component (b1) include, for example, structural units derived from ethylenically unsaturated monomer compounds having anionic groups other than carboxyl groups, such as sulfonic acid groups and phosphoric acid groups, and structural units derived from nonionic ethylenically unsaturated monomers and the like. These structural units can be introduced by copolymerizing monomers including an ethylenically unsaturated monomer compound having anionic groups other than carboxylic acid groups, such as sulfonic acid groups or phosphoric acid groups, or monomers including a nonionic ethylenically unsaturated monomer.

The ratio of the component (b1) may be from 0 mass % to 50 mass % of the total structural units in the crosslinked polymer. The ratio of the component (b1) may also be from 1 mass % to 50 mass %, or from 2 mass % to 50 mass %, or from 5 mass % to 50 mass %, or from 10 mass % to 50 mass %. When the component (b1) is included in the amount of at least 1 mass % of the total structural units in the crosslinked polymer, moreover, an improvement effect on lithium ion conductivity can be expected because affinity for the electrolyte solution is improved.

Of those listed above, a structural unit derived from a nonionic ethylenically unsaturated monomer is desirable as the component (b1) for obtaining an electrode with good bending resistance, and examples of nonionic ethylenically unsaturated monomers include amido group-containing ethylenically unsaturated monomers, nitrile group-containing ethylenically unsaturated monomers, ethylenically unsaturated monomers containing alicyclic structures, and ethylenically unsaturated monomers containing hydroxyl groups.

Examples of amido group-containing ethylenically unsaturated monomers include those listed above, and one of these alone or a combination of two or more may be used.

Examples of nitrile group-containing ethylenically unsaturated monomers include (meth)acrylonitile; (meth)acrylic acid cyanoalkyl ester compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide and the like. One of these alone or a combination of two or more may be used. Of these, acrylonitrile is preferred for its high nitrile group content.

Examples of ethylenically unsaturated monomers containing alicyclic structures include (meth)acrylic acid cycloalkyl esters optionally having aliphatic substituents, such as cyclopentyl (meth)acrylate, cyclohexyl (meth)acrylate, methyl cyclohexyl (meth)acrylate, t-butyl cyclohexyl (meth)acrylate, cyclodecyl (meth)acrylate and cyclododecyl (meth)acrylate; and isobornyl (meth)acrylate, adamantyl (meth)acrylate, dicyclopentenyl (meth)acrylate, dicyclopentenyl oxyethyl (meth)acrylate, dicyclopentanyl (meth)acrylate and cycloalkyl polyalcohol mono(meth)acrylates such as cyclohexane dimethanol mono(meth)acrylate and cyclodecane dimethanol mono(meth)acrylate, and one of these alone or a combination of two or more may be used.

Examples of ethylenically unsaturated monomers containing hydroxyl groups include hydroxyethyl (meth)acrylate, hydroxypropyl (meth)acrylate and hydroxybutyl (meth)acrylate, and one of these alone or a combination of two or more may be used.

To give the hydrophilic binder excellent adhesiveness, the crosslinked polymer or salt thereof preferably contains a structural unit derived from an amido group-containing ethylenically monounsaturated monomer, a nitrile group-containing ethylenically unsaturated monomer, or an ethylenically unsaturated monomer containing an alicyclic structure or the like. Moreover, by introducing a structural unit derived from a hydrophobic ethylenically unsaturated monomer with a solubility of not more than 1 g/100 ml in water as a component (c), it is possible to obtain strong interactions with the electrode materials and achieve good adhesiveness on the active material. An ethylenically unsaturated monomer containing an alicyclic structure is particularly desirable as the “hydrophobic ethylenically unsaturated monomer with a solubility of not more than 1 g/100 ml in water”, since this can yield a solid and well-integrated electrode mixture layer.

To improve the cycle characteristics of the resulting secondary battery, the crosslinked polymer or salt thereof preferably contains a structural unit derived from an ethylenically unsaturated monomer containing hydroxyl groups, and more preferably contains this structural unit in the amount of from 0.5 mass % to 50 mass %, or more preferably from 2.0 mass % to 50 mass %, or still more preferably from 10.0 mass % to 50 mass %.

Moreover, a meth(acrylic) acid ester may also be used as another nonionic ethylenically unsaturated monomer. Examples of (meth)acrylic acid esters include (meth)acrylic acid alkyl esters such as methyl (meth)acrylate, ethyl (meth)acrylate, butyl (meth)acrylate, isobutyl (meth)acrylate and 2-ethylhexyl (meth)acrylate; aromatic (meth)acrylic acid ester compounds such as phenyl (meth)acrylate, phenylmethyl (meth)acrylate and phenylethyl (meth)acrylate; and (meth)acrylic acid alkoxyalkyl ester compounds such as 2-methoxyethyl (meth)acrylate and 2-ethoxyethyl (meth)acrylate, and one of these alone or a combination of two or more may be used.

Considering the adhesiveness and cycle characteristics of the active material, an aromatic (meth)acrylic acid ester compound can be used by preference. A compound having ether bonds, such as 2-methoxyethyl (meth)acrylate, 2-ethoxyethyl (meth)acrylate or another (meth)acrylic acid alkoxy alkyl ester or the like, is preferred from the standpoint of further improving the lithium ion conductivity and high-rate characteristics, and 2-methoxyethyl (meth)acrylate is particularly desirable.

Of the nonionic ethylenically unsaturated monomers, a compound having acryloyl groups is preferred for obtaining a polymer with a long primary chain length due to the rapid polymerization speed, and for improving the adhesive strength of the hydrophilic binder. Furthermore, a compound with a glass transition temperature (Tg) of 0° C. or less of the homopolymer is preferred as the nonionic ethylenically unsaturated monomer from the standpoint of obtaining an electrode with good bending resistance.

The crosslinked polymer may also be in the form of a salt in which some or all of the carboxyl groups in the polymer have been neutralized. The type of salt is not particularly limited, but examples include alkali metal salts such as lithium salts, sodium salts and potassium salts; alkali earth metal salts such as magnesium salts, calcium salts and barium salts; other metal salts such as aluminum salts; and ammonium salts, organic amine salts and the like. Of these, alkali metal salts and alkali earth metal salts are preferred because they are unlikely to adversely affect the battery characteristics, and an alkali metal salt is especially preferred.

The polymer may also be a polymer having a crosslinked structure (the crosslinked polymer). The method of crosslinking in the crosslinked polymer is not particularly limited, and examples include crosslinking by the following methods.
1) Copolymerization of a crosslinkable monomer
2) Chain transfer to the polymer chain during radical polymerization
3) Crosslinking following synthesis of a polymer having reactive functional groups, and after addition of a crosslinking agent as necessary.

When the polymer has a crosslinked structure, a binder containing the polymer or its salt can have excellent binding strength. Of the above, the method using copolymerization of a crosslinkable monomer is preferred for ease of controlling the degree of crosslinking.

### Crosslinkable Monomer

Examples of crosslinkable monomers include polyfunctional polymerizable monomers having two or more polymerizable unsaturated groups, and monomers having self-crosslinkable functional groups such as hydrolyzable silyl groups and the like.

The polyfunctional polymerizable monomers are compounds having two or more polymerizable functional groups such as (meth)acryloyl or alkenyl groups in the molecule, and examples include polyfunctional (meth)acrylate compounds, polyfunctional alkenyl compounds, and compounds having both (meth)acryloyl and alkenyl groups and the like. One of these compounds may be used alone, or a combination of two or more may be used Of these, a polyfunctional alkenyl compound is preferable for ease of obtaining a uniform crosslinked structure, and a polyfunctional allyl ether compound having two or more allyl ether groups in the molecule is especially preferable.

Examples of polyfunctional (meth)acrylate compounds include di(meth)acrylates of dihydric alcohols, such as ethylene glycol di(meth)acrylate, propylene glycol di(meth)acrylate, 1,6-hexanediol di(meth)acrylate, polyethylene glycol di(meth)acrylate and polypropylene glycol di(meth)acrylate; tri(meth)acrylates of trihydric and higher polyhydric alcohols, such as trimethylolpropane ethylene oxide modified trimethylolpropane tri(meth)acrylate, tri(meth)acrylate, glycerin tri(meth)acrylate, pentaerythritol tri(meth)acrylate and pentaerythritol tetra(meth)acrylate; poly(meth)acrylates such as tetra(meth)acrylate and bisamides such as methylene bisacrylamide and hydroxyethylene bisacrylamide and the like.

Examples of polyfunctional alkenyl compounds include polyfunctional allyl ether compounds such as trimethylolpropane diallyl ether, trimethylolpropane triallyl ether, pentaerythritol diallyl ether, pentaerythritol triallyl ether, tetraallyl oxyethane and polyallyl saccharose; polyfunctional allyl compounds such as diallyl phthalate; and polyfunctional vinyl compounds such as divinyl benzene and the like.

Examples of compounds having both (meth)acryloyl and alkenyl groups include allyl (meth)acrylate, isopropenyl (meth)acrylate, butenyl (meth)acrylate, pentenyl (meth)acrylate and 2-(2-vinyloxyethoxy)ethyl (meth)acrylate and the like.

Specific examples of the monomers having self-crosslinkable functional groups include vinyl monomers containing hydrolysable silyl groups, N-methylol (meth)acrylamide, and the like. One of these compounds or a mixture of two or more may be used.

The vinyl monomers containing hydrolysable silyl groups are not particularly limited as long as they are vinyl monomers having at least one hydrolysable silyl group. Examples include vinyl silanes such as vinyl trimethoxysilane, vinyl triethoxysilane, vinyl methyl dimethoxysilane and vinyl dimethyl methoxysilane; acrylic acid esters containing silyl groups, such as trimethoxysilylpropyl acrylate, triethoxysilylpropyl acrylate and methyl dimethoxysilylpropyl acrylate; methacrylic acid esters containing silyl groups, such as trimethoxysilylpropyl methacrylate, triethoxysilylpropyl methacrylate, methyl dimethoxysilylpropyl methacrylate and dimethyl methoxysilylpropyl methacrylate; vinyl ethers containing silyl groups, such as trimethoxysilylpropyl vinyl ether; and vinyl esters containing silyl groups, such as vinyl trimethoxysilyl undecanoate and the like.

When the crosslinked polymer has been crosslinked with a crosslinkable monomer, the amount of the crosslinkable monomer used is preferably from 0.01 to 5.0 mass parts, or more preferably from 0.05 to 5.0 mass parts, or still more preferably from 0.1 to 3.0 mass parts, or yet more preferably from 0.2 to 2.0 mass parts per total 100 mass parts of the monomers (non-crosslinkable monomers) other than the crosslinkable monomer. To obtain good adhesiveness and make the electrode slurry more stable, the crosslinkable monomer is preferably used in the amount of at least 0.05 mass parts. The polymer tends to be more stable if the amount is not more than 5.0 mass parts. Similarly, the amount of the crosslinkable monomer used is preferably from 0.001 mol % to 2.5 mol %, or more preferably from 0.01 mol % to 2.0 mol %, or still more preferably from 0.03 mol % to 1.5 mol %, or yet more preferably from 0.05 mol % to 1.0 mol %, or even more preferably from 0.10 mol % to 0.50 mol % of the total amount of the monomers (non-crosslinkable monomers) other than the crosslinkable monomer.

### Aqueous Solution Viscosity of the Crosslinked Polymer

The crosslinked polymer preferably has a viscosity of not more than 10,000 mPa·s in a 2 mass % aqueous solution. If the viscosity of the 2 mass % aqueous solution is not more than 10,000 mPa·s, it is possible to achieve durability to adapt to volume changes of the active material during charging and discharging. The viscosity of the 2 mass % aqueous solution may also be not more than 5,000 mPa·s, or not more than 3,000 mPa·s, or not more than 2,000 mPa·s. The aqueous solution viscosity can be determined by first uniformly dissolving or dispersing an amount of the crosslinked polymer to give the predetermined concentration in water, and then measuring the B-type viscosity at 12 rpm (25° C.).

In water, the crosslinked polymer or salt thereof absorbs water and assumes a swelled state. In general, if the crosslinked polymer is crosslinked to a suitable degree, it is more likely to absorb water and swell the greater the amount of hydrophilic groups in the crosslinked polymer. In terms of the degree of crosslinking, the crosslinked polymer swells more easily if the degree of crosslinking is low. Even if the number of crosslinking points is the same, however, if the molecular weight (primary chain length) is high more crosslinking points will contribute to the shape of the three-dimensional network, inhibiting swelling of the crosslinked polymer. Therefore, the viscosity of the crosslinked polymer aqueous solution can be adjusted by adjusting the amount of hydrophilic groups in the crosslinked polymer, the number of crosslinking points and the primary chain length and the like. In this case, the number of crosslinking points can be adjusted for example by adjusting the amount of the crosslinkable monomer, the chain transfer reaction to the polymer chain and the post-crosslinking reactions and the like. Furthermore, the primary chain length of the polymer can be adjusted by setting conditions associated with the amount of radical generation, such as the initiator and polymerization temperature, and by considering chain transfer when selecting the polymerization solvent and the like.

### Particle Diameter of the Crosslinked Polymer

To achieve good binding performance of the binder containing the crosslinked polymer, the crosslinked polymer in the slurry composition should be well dispersed as water-swelled particles with a suitable particle diameter, rather than existing as large particle size agglomerates (secondary aggregates).

When a crosslinked polymer with a degree of neutralization of from 70 to 100 mol % based on the carboxyl groups of the crosslinked polymer is dispersed in water, the particle diameter of the crosslinked polymer (water-swelled particle diameter) is preferably in the range of a volume-based median diameter of from 0.1 to 10.0 microns. This particle diameter is more preferably in the range of from 0 1 to 8.0 microns, or still more preferably in the range of from 0.1 to 7.0 microns, or yet more preferably in the range of from 0.2 to 5.0 microns, or even more preferably in the range of from 0.5 to 3.0 microns. If the particle diameter is in the range of from 0.1 to 10.0 microns, because the particles are uniformly present at a suitable size in the slurry composition, the slurry composition is highly stable and excellent adhesiveness can be achieved. If the particle diameter exceeds 10.0 microns, there is a risk that adhesiveness may be insufficient as discussed above. The coating properties may also be inadequate in the sense that it may be difficult to obtain a smooth coating surface. If the particle diameter is less than 0.1 micron, on the other hand, there may be problems in terms of stable manufacture. This water-swelled particle diameter can be determined by methods conforming to those described in this Description.

Furthermore, the particle diameter of crosslinked polymer when dried (dried particle diameter) is preferably a volume-based median diameter of from 0.03 to 3 microns This particle diameter is more preferably in the range of from 0.1 to 1 microns, or still more preferably in the range of from 0.3 to 0.8 microns.

In the slurry composition, the crosslinked polymer is preferably used in the form of a salt in which acid groups such as carboxyl groups derived from the ethylenically unsaturated carboxylic acid monomer have been neutralized to a degree of neutralization of at least 20 mol %. The degree of neutralization is more preferably at least 50 mol %, or still more preferably at least 70 mol %, or yet more preferably at least 75 mol %, or even more preferably at least 80 mol %, or especially at least 85 mol %. The maximum degree of neutralization is 100 mol %, and may also be 98 mol % or 95 mol %. The range of the degree of neutralization can be set by combining these minimum and maximum values, and may be for example from 50 mol % to 100 mol %, or from 75 mol % to 100 mol %, or from 80 mol % to 100 mol % A degree of neutralization of at least 20 mol % is desirable for obtaining good water swellability and a dispersion stabilization effect In this Description, the degree of neutralization can be calculated from the charged values of the monomer having acid groups such as carboxyl groups and the neutralizing agent used for neutralization. The degree of neutralization can be confirmed from the intensity ratio of a peak derived from C═O groups of carboxylic acids and a peak derived from C═O groups of carboxylic acid salts in IR measurement of a powder obtained by drying the crosslinked polymer or salt thereof for 3 hours at 80° C. under reduced pressure.

### Method for Manufacturing the Crosslinked Polymer

A known polymerization method such as solution polymerization, precipitation polymerization, suspension polymerization or emulsion polymerization may be used for the crosslinked polymer, but precipitation polymerization and suspension polymerization (reverse-phase suspension polymerization) are preferred from the standpoint of productivity. A heterogenous polymerization method such as precipitation polymerization, suspension polymerization or emulsion polymerization is preferred for obtaining good performance in terms of binding ability and the like, and a precipitation polymerization method is especially preferred.

Precipitation polymerization is a method of manufacturing a polymer by performing a polymerization reaction in a solvent that dissolves the starting material (unsaturated monomer) but effectively does not dissolve the resulting polymer. As polymerization progresses, the polymer particles grow larger by aggregation and polymer growth, and a dispersion of secondary polymer particles is obtained, in which primary particles of tens of nanometers to hundreds of nanometers are aggregated to the secondary polymer particles of micrometers to tens of micrometers in size. A dispersion stabilizer may be used to control the particle size of the polymer.

Such secondary aggregation can also be suppressed by selecting a dispersion stabilizer, a polymerization solvent and the like. In general, precipitation polymerization in which secondary aggregation is suppressed is also referred to as dispersion polymerization.

In a case of precipitation polymerization, the polymerization solvent may be selected from water and various organic solvents and the like depending on a type of monomer used and the like. To obtain a polymer with a longer primary chain length, it is desirable to use a solvent with a small chain transfer constant.

Specific examples of the polymerization solvents include water-soluble solvents such as methanol, t-butyl alcohol, acetone, methyl ethyl ketone, acetonitrile and tetrahydrofuran, and benzene, ethyl acetate, dichloroethane, n-hexane, cyclohexane and n-heptane and the like, and one of these or a combination of two or more may be used Mixed solvents of any of these with water may also be used. In the present teachings, a water-soluble solvent means one having a solubility of more than 10 g/100 ml in water at 20° C.

Of these solvents, acetonitrile and methyl ethyl ketone are preferred because, for example, polymerization stability is good, with less production of coarse particles and adhesion to the reaction vessel, because the precipitated polymer fine particles are less liable to secondary aggregation (or any secondary aggregates that occur are easily broken up in an aqueous medium), because the chain transfer constant is low, resulting in a polymer with a high degree of polymerization (long primary chain length), and because an operation is easier in a process neutralization described below

A known polymerization initiator such as an azo compound, organic peroxide or inorganic peroxide may be used as a polymerization initiator, without any particular restrictions. The conditions of use may be adjusted to achieve a suitable amount of radical generation, using a known method such as thermal initiation, redox initiation using a reducing agent, UV initiation or the like. To obtain a crosslinked polymer with a long primary chain length, the conditions are preferably set so as to reduce the amount of radical generation within the allowable range of manufacturing time.

Given 100 mass parts as the total amount of the monomer components used, the polymerization initiator is preferably used in the amount of from 0.001 to 2 mass parts, or from 0.005 to 1 mass part, or from 0.01 to 0.1 mass parts for example. If the amount of the polymerization initiator is at least 0.001 mass parts, a stable polymerization reaction can be achieved, while if it is not more than 2 mass parts it is easy to obtain a polymer with a long primary chain length.

The polymerization temperature depends on conditions such as the types and concentrations of the monomers used, but is preferably from 0° C. to 100° C., or more preferably from 20° C. to 80° C. The polymerization temperature may be uniform, or may be changed during the period of the polymerization reaction. The polymerization time is preferably from 1 minute to 20 hours, or more preferably from 1 hour to 10 hours.

### 3-2. The Non-crosslinked Polymer

The non-crosslinked polymer is explained here using an ethylenically unsaturated carboxylic acid monomer as the hydrophilic vinyl monomer.

### Structural Unit Derived From Ethylenically Unsaturated Carboxylic Acid Monomer

The non-crosslinked polymer contained in the hydrophilic binder may contain a structural unit derived from an ethylenically unsaturated carboxylic acid monomer (the component (a1)) in the amount of from 50 mass % to 100 mass %. The method for introducing the component (a1) into the non-crosslinked polymer may be similar to the method described for the component (a1) of the crosslinked polymer. It may also be a method of saponifying a polymer containing a structural unit derived from a (meth)acrylic acid alkyl ester compound (described above as component (b1) of the crosslinked polymer), and from the standpoint of easily promoting a saponification reaction and the like, methyl acrylate or methyl methacrylate is preferred as the (meth)acrylic acid alkyl ester compound, and one of these alone or a combination of two or more may be used.

The non-crosslinked polymer is more viscous than the crosslinked polymer. This is thought to be because the non-crosslinked polymer bas wide molecular chains, while the crosslinked polymer is in particle form, giving it a smaller apparent molecular weight.

From the standpoint of solubility in water, the content of the component (a1) in the non-crosslinked polymer may be from 50 mass % to 100 mass %, or preferably from 60 mass % to 100 mass %, or more preferably from 70 mass % to 100 mass %, or still more preferably from 80 mass % to 100 mass % of the total structural units in the non-crosslinked polymer.

### Other Structural Units

In addition to the component (a1), the non-crosslinked polymer may also contain a structural unit (the component (b1)) derived from another ethylenically unsaturated monomer that can be copolymerized with the other components.

The method for introducing the component (b1) may be similar to the method described with respect to the component (b1) of the crosslinked polymer. It may also be a method of saponifying a polymer containing structural units derived from a vinyl ester compound such as vinyl acetate or vinyl propionate, and from the standpoint of easily obtaining the raw materials, this vinyl ester compound is preferably vinyl acetate, and one kind alone or a combination of two or more kinds may be used.

The ratio of the component (b1) may be from 0 mass % to 50 mass % of the total structural units in the non-crosslinked polymer. The ratio of the component (b1) may also be from 1 mass % to 50 mass %, or from 2 mass % to 50 mass %, or from 5 mass % to 50 mass %, or from 10 mass % to 50 mass %.

The non-crosslinked polymer may also be in the form of a salt in which all or part of the carboxyl groups contained in the polymer have been neutralized. The type of salt is not particularly limited, but examples include alkali metal salts of lithium, sodium, potassium and the like; alkali earth metal salts such as magnesium salts, calcium salts and barium salts; other metal salts such as aluminum salts; and ammonium salts, organic amine salts and the like. Of these, alkali metal salts and alkali earth metal salts are preferred because they are unlikely to adversely affect the battery characteristics, and an alkali metal salt is especially preferred.

In the slurry composition, the non-crosslinked polymer is preferably used in the form of a salt in which the acid groups such as carboxyl groups derived from ethylenically unsaturated carboxylic acid monomers have been neutralized to a degree of neutralization of at least 20 mol %. The degree of neutralization is preferably at least 50 mol %, or more preferably at least 70 mol %, or still more preferably at least 75 mol %, or yet more preferably at least 80 mol %, or especially at least 85 mol %. The maximum degree of neutralization is 100 mol %, and may also be 98 mol % or 95 mol %. The range of the degree of neutralization can be set by appropriately combining these minimum and maximum values, and may be for example from 50 mol % to 100 mol %, or from 75 mol % to 100 mol %, or from 80 mol % to 100 mol %. A degree of neutralization of at least 20 mol % is desirable for ensuring solubility in water. In this Description, the degree of neutralization can be calculated from the preparation values of the monomers having acid groups such as carboxyl groups and the neutralizing agent used for neutralization. The degree of neutralization can be confirmed from the peak intensity ratio of a peak derived from C═O groups of carboxylic acids a the peak derived from C═O groups of carboxylic acid salts in IR measurement of a powder of the crosslinked polymer or salt thereof which has been dried for 3 hours at 80° C. under reduced pressure conditions.

The weight-average molecular weight (Mw) of the non-crosslinked polymer is not particularly limited, but to obtain a highly adhesive electrode mixture layer, is preferably at least 5,000, or more preferably at least 10,000. The Mw may also be at least 100,000, or at least 500,000, or at least 1,000,000. There is no particular upper limit to the Mw, but from the standpoint of handling during manufacture, it may be not more than 10,000,000, or not more than 7,000,000, or not more than 5,000,000, or not more than 3,000,000 for example. The Mw here can be determined by a method corresponding to the methods described in this Description, according to the structural units of the non-crosslinked polymer.

When the crosslinked polymer and non-crosslinked polymer are used in the hydrophilic binder, the amount of the non-crosslinked polymer used is preferably from 7.5 mass parts to 200 mass parts per total 100 mass parts of the crosslinked polymer. The amount of the non-crosslinked polymer may also be at least 15 mass parts, or at least 25 mass parts, or at least 35 mass parts, or at least 45 mass parts. The maximum amount may be not more than 190 mass parts, or not more than 180 mass parts, or not more than 170 mass parts, or not more than 160 mass parts. The range thereof can be set by appropriately combining these minimum and maximum values, and may be for example from 15 to 190 mass parts, or from 25 to 180 mass parts, or from 35 to 170 mass parts, or from 35 to 160 mass parts.

Thus, a specific amount of the non-crosslinked polymer can also be combined and used with the crosslinked polymer, so that when the solids concentration of the secondary battery electrode slurry composition is higher than in the past, it possible to ensure the coating properties by reducing the viscosity of the electrode slurry, and obtain a secondary battery exhibiting excellent cycle characteristics. These effects can be obtained if the non-crosslinked polymer is used in the amount of at least 7.5 mass parts. However, adequate coating properties may not be obtained if the non-crosslinked polymer is used in an amount exceeding 200 mass parts.

### Method for Manufacturing Non-crosslinked Polymer

A known polymerization method such as solution polymerization, precipitation polymerization, suspension polymerization or emulsion polymerization may be used for the non-crosslinked polymer, and this method may be selected according to the molecular weight, composition and the like.

A known polymerization initiator such as an azo compound, organic peroxide or inorganic peroxide may be used as the polymerization initiator, with no particular limitations. The conditions of use can be adjusted by known methods such as thermal initiation, redox initiation using a reducing agent or UV initiation so as to generate a suitable amount of radicals.

A known chain transfer agent may also be used as necessary to adjust the molecular weight or the like.

### Aqueous Solution Viscosity of Non-crosslinked Polymer

The viscosity of a 2 mass % aqueous solution of the non-crosslinked polymer is preferably not more than 10,000 mPa·s. If the viscosity of a 2 mass % aqueous solution is not more than 10,000 mPa·s, it is possible to achieve durability to adapt to volume changes of the active material during charging and discharging. The viscosity of a 2 mass % aqueous solution may also be not more than 5,000 mPa·s, or not more than 3,000 mPa·s, or not more than 2,000 mPa·s. The aqueous solution viscosity can be determined by first uniformly dissolving or dispersing an amount of the non-crosslinked polymer to give the predetermined concentration in water, and then measuring the B-type viscosity at 12 rpm (25° C.).

### 4. Other Components

The slurry composition may also contain another binder component such as styrene-butadiene rubber (SBR) type latex, acrylic latex or polyvinylidene fluoride latex. When another binder component is included, the amount thereof may be for example from 0.1 to 5 mass parts, or from 0.1 to 2 mass parts, or from 0.1 to 1 mass part per total 100 mass parts of the active material. If the amount of the other binder component exceeds 5 mass parts resistance may increase, and the high-rate characteristics may be inadequate. Of those listed above, SBR latex is preferred for achieving a superior balance between adhesiveness and bending resistance.

In terms of timing, the latex is preferably added in step C from the standpoint of suppressing latex aggregation due to shearing.

The SBR latex is an aqueous dispersion of a copolymer having structural units derived from an aromatic vinyl monomer such as styrene and an aliphatic conjugated diene monomer such as 1,3-butadiene. In addition to styrene, examples of the aromatic vinyl monomer include alpha-methylstyrene, vinyl toluene and divinyl benzene, and one or two or more of these may be used. Principally from the standpoint of binding ability, the structural unit derived from the aromatic vinyl monomer may constitute from 20 to 70 mass %, or for example from 30 to 60 mass % of the copolymer.

In addition to 1,3-butadiene, examples of the aliphatic conjugated diene monomer include 2-methyl-1,3-butadiene, 2,3-dimethyl-1,3-butadiene and 2-chloro-1,3-butadiene, and one or two or more of these may be used. Considering the binding ability of the binder and the flexibility of the resulting electrode, the structural unit derived from the aliphatic conjugated diene monomer may constitute from 30 to 70 mass % or for example from 40 to 60 mass % of the copolymer.

In addition to the aforementioned monomers, a nitrile group-containing monomer such as (meth)acrylonitrile, a carboxyl group-containing monomer such as (meth)acrylic acid, itaconic acid or maleic acid, or an ester group-containing monomer such as methyl (meth)acrylate may also be included in the SBR latex as a copolymerized monomer with the aim of further improving performance including adhesiveness.

Structural units derived from such other monomers in the copolymer may be included in the range of from 0 to 30 mass % or for example from 0 to 20 mass % of the copolymer

### 5. Method for Manufacturing Secondary Battery Electrode Slurry Composition

The method for manufacturing the secondary battery electrode slurry composition of the present invention comprises the following Step A, Step B and Step C using an active material, a thickener, a hydrophilic binder and water.

Step A: A step of kneading a composition with a solids concentration of from 60 to 80 mass % containing an active material, a thickener and water to obtain a kneaded product,

Step B: A step of adding a hydrophilic binder (different from the thickener) and water to the kneaded product obtained in Step A, and kneading this to obtain a second kneaded product, and

Step C: A step of adjusting the solids concentration of the second kneaded product to from 40 to 60 mass %.

As long of the effects of the invention are obtained, a part of the hydrophilic binder may also be added in the Step A, but the effect of reducing the viscosity of the slurry composition is greater if all of the hydrophilic binder is added in the Step B.

The viscosity of the electrode slurry can be reduced even if the solids concentration of the slurry composition is high, and excellent productivity can be achieved if part or all of the hydrophilic binder is added in Step B after the composition containing the thickener has been kneaded in the Step A.

If all of the thickener and the hydrophilic binder are added before kneading unlike in the method of the present invention, the viscosity of the slurry composition increases dramatically, and productivity declines. This is thought to be because adsorption of the hydrophilic binder and thickener on the active material occurs competitively, resulting in more thickener existing in a free state in the medium.

In the manufacturing method of the present invention, on the other hand, it seems that in Step A by kneading the composition with the thickener without including the hydrophilic binder, it is possible to reduce the viscosity of the slurry composition because more of the thickener is then adsorbed by the active material and less of the thickener exists in a free state in the medium.

The solids concentration of the composition in Step A is from 60 to 80 mass %, and to promote adsorption of the thickener on the active material by strong shearing force applied to the composition and further reduce the viscosity of the resulting electrode slurry, the concentration is preferably from 61 to 78 mass %, or more preferably from 62 to 76 mass %, or still more preferably from 63 to 74 mass %, or yet more preferably from 66 to 72 mass %, or even more preferably from 68 to 72 mass %, or especially from 68 to 70 mass %.

To promote adsorption of the thickener on the active material and reduce the viscosity of the resulting electrode slurry while achieving excellent productivity, the kneading time in the Step A is preferably from 10 to 60 minutes, or more preferably from 20 to 60 minutes, or still more preferably from 25 to 60 minutes.

The Step B may also include the following Step B1.

Step B1: A step of adding an aqueous solution of the hydrophilic binder to the first kneaded product obtained in Step A, and kneading this to obtain a second kneaded product.

Because the hydrophilic binder is made into an aqueous solution rather than being added in powder form, including a Step B1 in the Step B is desirable for further reducing the viscosity of the resulting electrode slurry and obtaining a smooth secondary battery electrode by suppressing the occurrence of so called “stepchildren”.

The Step B may also include the following Steps B2 and B3.

Step B2: A step of adding the hydrophilic binder to the first kneaded product obtained in Step A, and kneading this.

Step B3: A step of adding water after the Step B2, and kneading this to obtain a second kneaded product.

Including both a Step B2 and a Step B3 in the Step B is desirable because when the hydrophilic binder is in powder form, the hydrophilic binder can be uniformly dispersed and dissolved in the electrode slurry by kneading in the Step B2, thereby reducing the viscosity of the resulting electrode slurry.

The amount of the thickener used in the slurry composition is for example from 0.1 to 20 mass parts per total 100 mass parts of the active material. This amount may also be from 0.2 to 10 mass parts, or from 0.3 to 8 mass parts, or from 0.4 to 5 mass parts for example. If the amount of the thickener is at least 0.1 mass parts, adequate adhesiveness can be obtained. It is also possible to ensure the dispersion stability of the active material and the like, and form a uniform mixture layer. If the amount of the thickener is not more than 20 mass parts, the slurry composition will not become to viscous, and the coating properties on the collector can be ensured. As a result, it is possible to form a mixture layer with a uniform and smooth surface.

The amount of the hydrophilic binder used in the slurry composition is for example from 0.1 to 20 mass parts per total 100 mass parts of the active material. This amount may also be from 0.2 to 10 mass parts, or from 0.3 to 8 mass parts, or from 0.4 to 5 mass parts for example. If the amount of the hydrophilic binder is at least 0.1 mass parts, adequate adhesiveness can be obtained. It is also possible to ensure the dispersion stability of the active material and the like, and form a uniform mixture layer. If the amount of the hydrophilic binder is not more than 20 mass parts, the slurry composition will not become to viscous, and the coating properties on the collector can be ensured. As a result, it is possible to form a mixture layer with a uniform and smooth surface.

The amount of the active material used in the slurry composition is in the range of for example from 20 to 40 mass %, or from 25 to 40 mass % of the total amount of the slurry composition. An amount of the active material of at least 20 mass % is advantageous for suppressing migration of the hydrophilic binder and the like, and also from the standpoint of medium drying costs. If the amount is not more than 40 mass %, it is possible to ensure the flowability and coating properties of the slurry composition, and form a uniform mixture layer.

The slurry composition uses water as a medium. Mixed solvents with water-soluble organic solvents including lower alcohols such as methanol and ethanol, carbonates such as ethylene carbonate, ketones such as acetone, and tetrahydrofuran, N-methylpyrrolidone and the like may also be used to adjust the properties, drying performance and the like of the slurry composition. The ratio of water in the mixed solvent may be at least 50 mass % for example, or at least 70 mass % for example.

When the slurry composition is made into a coatable slurry state, the content of solvents including water as a percentage of the total slurry composition may be in the range of from 40 to 60 mass %, or from 40 to 55 mass % for example from the standpoint of the slurry coating properties, energy costs of drying and productivity.

The secondary battery electrode slurry composition of the present invention has an active material, a thickener, a hydrophilic binder and water as essential components, and is obtained by mixing these components by known methods. The method for mixing the components is not particularly limited, and a known method may be used, but a preferred method is to first dry blend the powder components including the active material and thickener and then mix in a dispersion medium such as water, followed by dispersion kneading. When the slurry composition is obtained in a slurry state, it is preferably made into a slurry with no dispersion irregularities or aggregates. A known mixer such as a planetary mixer, thin film swirl mixer or self-rotating mixer may be used as the mixing means, but a planetary mixer is preferred for obtaining a good dispersion state in a short amount of time. When a thin film swirl mixer is used, it is desirable to perform pre-dispersion in advance with an agitator such as a Disper mixer. The pH of the slurry composition is not particularly limited as long as the effects of the invention are obtained, but is preferably less than 12.5, or more preferably less than 11.5 when CMC is included for example since there is less concern about hydrolysis, or still more preferably less than 10.5. The viscosity of the slurry composition is also not particularly limited as long as the effects of the invention are obtained, but for example the B type viscosity at 20 rpm (25° C.) may be in the range of from 100 to 12,000 mPa·s, or for example from 500 to 11,000 mPa·s, or from 1,000 to 10,000 mPa·s. Good coating properties can be ensured if the viscosity of the slurry is within this range.

### 6. Method for Manufacturing Secondary Battery Electrode

The secondary battery electrode of the present invention is provided with a mixture layer formed from the secondary battery electrode slurry composition of the invention on the surface of a collector made of copper foil, aluminum foil or the like. The mixture layer is formed by first coating the slurry composition on the surface of the collector, and then drying to remove the water or other medium. The method for coating the slurry composition is not particularly limited, and a known method such as a doctor blade method, dip method, roll coating method, comma coating method, curtain coating method, gravure coating method or extrusion method may be adopted. Drying may also be accomplished by a known method such as hot air blowing, pressure reduction, (far) infrared irradiation, microwave irradiation or the like.

The mixture layer obtained after drying is normally subjected by pressing treatment with a metal press, roll press or the like. The active material and the hydrophilic binder are compacted together by pressing, which can improve the strength of the mixture layer and its adhesiveness with the collector. The thickness of the mixture layer may be adjusted by pressing to about from 30% to 80% of the pre-pressed thickness, and the thickness of the mixture layer after pressing is normally about from 4 to 200 microns.

### 7. Method for Manufacturing Secondary Battery

A secondary battery can be prepared by providing a separator and an electrolyte solution with the secondary battery electrode relating to the invention. The electrolyte solution may be in the form of a liquid or a gel.

The separator is disposed between the positive and negative electrodes of the battery, and serves to prevent short-circuits due to contact between the electrodes, hold the electrolyte solution and ensure ion conductivity. The separator is preferably an insulating finely porous film, having good ion permeability and mechanical strength. Specific materials that can be used include polyolefins such as polyethylene and polypropylene, and polytetrafluoroethylene and the like.

A commonly used known electrolyte solution may be used according to the type of active material. In the case of a lithium-ion secondary battery, specific examples of solvents include cyclic carbonates with high dielectric constants and high electrolyte dissolution ability, such as propylene carbonate and ethylene carbonate, and low-viscosity linear carbonates such as ethyl methyl carbonate, dimethyl carbonate and diethyl carbonate, and these may be used alone or as mixed solvents. The electrolyte solution is used as a solution of a lithium salt such as LiPF₆, LiSbF₆, LiBF₄, LiClO₄ or LiAlO₄ dissolved in these solvents. In the case of a nickel-hydrogen secondary battery, a potassium hydroxide aqueous solution may be used as the electrolyte solution. To obtain secondary battery, a positive electrode plate and negative electrode plate are separated by separators, made into a wound or laminated structure, and enclosed in a case or the like.

As explained above, a secondary battery provided with an electrode having a mixture layer formed from the secondary battery electrode slurry composition disclosed in this Description exhibits good durability (cycle characteristics) even after repeated charge and discharge, and is suitable as a secondary battery for automotive use or the like.

### EXAMPLES

The present invention is explained in detail below based on examples, but the present invention is not limited by these examples. Unless otherwise specified, “parts” and “%” indicate mass parts and mass % values.

In the examples below, the crosslinked polymer was evaluated by the following methods.

### Hydrophilic Binder

### Manufacturing Example 1: Manufacture of Hydrophilic Binder R-1

A reactor provided with a stirring blade, a thermometer, a condenser and a nitrogen introduction pipe was used for polymerization.

567 parts of acetonitrile, 2.2 parts of deionized water, 100 parts of acrylic acid (hereunder called “AA”), 0.9 parts (0.30 mol % of above AA) of trimethylol propane diallyl ether (manufactured by Osaka Soda Co., Ltd., product name “Neoallyl T-20”), and triethylamine corresponding to 1.0 mol % of the AA were loaded into the reactor. The inside of the reactor was thoroughly purged with nitrogen, and heated until the internal temperature rose to 55° C. After the internal temperature was confirmed to have stabilized at 55° C., 0.040 parts of 2,2′-azobis(2,4-dimethylvaleronitrile) (manufactured by Fujifilm Wako Pure Chemical Industries, product name “V-65”) were added as a polymerization initiator, and this was taken as the polymerization initiation point since cloudiness was observed in the reaction solution. The monomer concentration at this point was calculated as 15.0%. 12 hours after polymerization initiation, cooling of the polymerization reaction solution was initiated, and once the internal temperature had dropped to 25° C., 52.4 parts of a powder of lithium hydroxide monohydrate (hereunder called “LiOH·H₂O”) were added. After addition, this was stirred continuously for 12 hours at room temperature to obtain a slurry-type polymerization reaction solution comprising particles of a hydrophilic polymer R-1 (lithium salt, degree of neutralization 90 mol %) dispersed in a medium.

The resulting polymerization reaction solution was centrifuged to precipitate polymer particles, and the supernatant was removed. The precipitate was then redispersed in acetonitrile in the same amount as the polymerization reaction solution, and the washing operation of precipitating the polymer particles by centrifugation and removing the supernatant was repeated twice. The precipitate was collected and dried for 3 hours at 80° C. under reduced-pressure conditions to remove the volatile components and obtain a powder of the hydrophilic polymer R-1. Because the hydrophilic polymer R-1 is hygroscopic, it was stored sealed in a container having water vapor barrier properties. When the powder of the hydrophilic polymer R-1 was subjected to IR measurement and the degree of neutralization was determined from the intensity ratio of the peak derived from C═O groups of carboxylic acid and the peak derived from C═O groups of lithium carbonate, the result was the same as the value calculated from the preparation values (90 mol %).

The particle diameter in the water medium was 1.68 microns as measured by the following methods.

### Measurement of Particle Diameter in water Medium (Water-swelled Particle Diameter)

0.25 g of the powder of the hydrophilic polymer R-1 and 49.75 g of deionized water were measured into a 100 cc container, which was then set in a rotating/revolving stirrer (Thinky Co., Awatori Rentaro AR-250). This was then stirred (rotating speed 2,000 rpm/revolving speed 800 rpm, 7 minutes) and defoamed (rotating speed 2,200 rpm/revolving speed 60 rpm, 1 minute) to prepare a hydrogel of R-1 in a water-swelled state.

Next, the particle size distribution of this hydrogel was measured with a laser diffraction/scattering particle size distribution analyzer (Micro-Trak MT-3300EXII, manufactured by Micro-Trak Bell) using deionized water as the dispersion medium. When an excess of the dispersion medium was circulated relative to the hydrogel, and the hydrogel was added in an amount sufficient to yield an appropriate scattering light intensity, the shape of the measured particle size distribution stabilized within a few minutes. Once stability was confirmed the particle size distribution was measured, and the volume-based medium diameter (D50) was determined as a typical particle size value.

### Manufacturing Example 2: Manufacture of Hydrophilic Binder R-2

A reactor provided with a stirring blade, a thermometer, a condenser and a nitrogen introduction pipe was used for polymerization.

567 parts of acetonitrile, 2.2 parts of deionized water, 80 parts of AA, 0.9 parts of Neoallyl T-20 (0.33 mol % of total of above AA and 2-hydroxyethyl acrylate described below) and triethylamine corresponding to 1.0 mol % of the AA were loaded into the reactor. The inside of the reactor was thoroughly purged with nitrogen, and heated to an internal temperature of 55° C. After the internal temperature was confirmed to have stabilized at 55° C., 0.040 parts of V-65 were added as a polymerization initiator, and this was taken as the polymerization initiation point since cloudiness was observed in the reaction solution. 2 hours after polymerization initiation, 20.0 parts of 2-hydroxyethyl acrylate were added all at once. The monomer concentration was calculated to be 15.0%. 12 hours after polymerization initiation, cooling of the polymerization reaction solution was initiated, and once the internal temperature had dropped to 25° C., 41.9 parts of LiOH·H₂O powder were added. After addition, this was stirred continuously for 12 hours at room temperature to obtain a slurry-type polymerization reaction solution comprising particles of a hydrophilic polymer R-2 (lithium salt, degree of neutralization 90 mol %) dispersed in a medium.

The resulting polymerization reaction solution was centrifuged to precipitate polymer particles, and the supernatant was removed. The precipitate was then redispersed in acetonitrile in the same amount as the polymerization reaction solution, and the washing operation of precipitating the polymer particles by centrifugation and removing the supernatant was repeated twice. The precipitate was collected and dried for 3 hours at 80° C. under reduced-pressure conditions to remove the volatile components and obtain a powder of the hydrophilic polymer R-2. Because the hydrophilic polymer R-2 is hygroscopic, it was stored sealed in a container having water vapor barrier properties. When the powder of the hydrophilic polymer R-2 was subjected to IR measurement and the degree of neutralization was determined from the intensity ratio of the peak derived from C═O groups of carboxylic acid and the peak derived from C═O groups of lithium carbonate, the result was the same as the value calculated from the preparation values (90 mol %). The particle size was 1.40 microns as measured in a water medium in the same way as Example 1.

### Hydrophilic Binder R-3

The details of the R-3 used in the Examples and Comparative Examples are shown below.
R-3: Non-crosslinked sodium polyacrylate neutralized salt, product name “Aron® A-20-PX, manufactured by Toagosei, Mw 5,000,000.

The Mw as obtained with a GPC (HLC-8420 gel permeation chromatograph, manufactured by Tosoh) matched the catalog value. An aqueous solution of sodium nitrate dissolved at a concentration of 0.1 M was used as the eluent, and sodium polyacrylate was used as the standard substance.

### Manufacturing Example 3: Manufacture of Hydrophilic Binder R-4

A reactor provided with a stirring blade, a thermometer, a condenser and a nitrogen introduction pipe was used for polymerization.

400 parts of pure water and 100 parts of N-acryloyl morpholine (manufactured by Kojinsha, hereunder called “ACMO”) were loaded into the reactor. The inside of the reactor was thoroughly purged with nitrogen, and heated to an internal temperature of 45° C. After the internal temperature was confirmed to have stabilized at 45° C., 0.084 parts of 2,2′-azobis[2-(2-imidazoline-2-yl)propane] disulfate dihydrate (manufactured by Fujifilm Wako Pure Chemical, product name “VA-046B”) were added as a polymerization initiator to initiate polymerization. 4 hours after polymerization initiation, cooling of the polymerization reaction solution was initiated, to obtain an aqueous solution of a hydrophilic polymer R-4.

The Mw as obtained with a GPC (HLC-8320 gel permeation chromatograph, manufactured by Tosoh) was 2,126,600, the number-average molecular weight (Mn) was 686,000, and the molecular weight distribution (PDI) was 3.1. Dimethylformamide containing lithium bromide monohydrate dissolved to a concentration of 10 mM was used as the eluent in this case, and methyl polymethacrylate was used as the standard substance. The ACMO polymerization rate as calculated with a GC (GC-2014 gas chromatograph, manufactured by Shimadzu Corp.) was 100%.

The resulting polymerization reaction solution was dried overnight at 100° C., and pulverized to obtain a powder of a hydrophilic polymer R-4. Because the hydrophilic polymer R-4 is hygroscopic, it was stored sealed in a container having water vapor barrier properties.

### Example 1

### Manufacture of Secondary Battery Electrode Slurry Composition

77.6 parts of artificial graphite (product name “SCMG-CF”, manufactured by Showa Denko) as an active material and 19.4 parts of silicon monoxide (particle size 5 microns, manufactured by Osaka Titanium Technologies) were loaded into an 0.6 L planetary mixer (Hivis Mix 2P-03, manufactured by Primix), and 1.5 parts of carboxymethyl cellulose sodium (CMC) were added as a thickener. This was then dry mixed for 7 minutes at 40 rpm to obtain a powder mixture.

Next, in Step A, 43.5 parts of deionized water were then added to the powder mixture to adjust the solids concentration to 69.4%, and this was then kneaded for 30 minutes at a speed of 95 rpm of the planetary mixer to obtain a first kneaded product. During this process, 99.4 g of the mixture was kneaded in the planetary mixer, and 0.25 A of current was applied at a voltage of 100 V (252 W/kg). The kneading initiation temperature was 26.1° C., but due to heat generated by kneading the temperature of the kneaded product bad risen to 36.4° C. by the end of kneading.

In Step B, 1.0 part of the hydrophilic binder R-1 and 31.5 parts of deionized water were then added to the first kneaded product to adjust the solids concentration to 57.0%, and this was then kneaded for 20 minutes at 95 rpm in the planetary mixer to obtain a second kneaded product. During this process, 122.15 g of mixture was kneaded in the planetary mixture, and 0.15 A of current were applied at a voltage of 100 V (123 W/kg). The kneading initiation temperature was 31.9° C., and the temperature of the kneaded product at the end of kneading was very little changed at 32.6° C.

Finally, in Step C, deionized water and 1.5 parts (as solids) of styrene butadiene rubber (SBR) latex were added to the second kneaded product to adjust the solids concentration to 53%, and this was gently mixed for 10 minutes at 95 rpm in the planetary mixer and then vacuum defoamed for 5 minutes at 10 rpm in the planetary mixer to produce a slurry mixture for a negative electrode (negative electrode slurry).

### Measuring Viscosity of Negative Electrode Slurry

The negative electrode slurries obtained in the following examples and comparative examples were adjusted to a temperature of 25° C.±1° C., and the slurry viscosity was measured at 12 rpm with a B type viscometer (TVB-10, manufactured by Toki Sangyo).

### Preparing Negative Electrode Plate

Next, each slurry was coated with a variable applicator onto a 20 micron-thick collector (copper foil), and dried in a ventilation drier for 30 minutes at 80° C. to form a mixture layer. This was then rolled so that the mixture layer had a thickness of 50±5 microns and a mixture density of 1.60±0.10 g/cm³, punched to a 1 cm×6 cm size for peel strength testing, and dried for 8 hours at 130° C. under reduced pressure to obtain a negative electrode plate.

### 180° Peel Strength (Adhesiveness)

The mixture layer side of each 1 cm×6 cm negative electrode plate was affixed with double-sided tape (Nice Tack NW-20, manufactured by Nichiban) to a 3 cm×9 cm acrylic plate to prepare a sample for peel strength testing. 180° peeling was performed at a tensile rate of 100 mm/minute and a measurement temperature of 25° C. with a tensile testing apparatus (Imada MX-500N electrical test stand, Imada DSY-5N digital force gauge) to evaluate adhesiveness by measuring the peel strength between the mixture layer and the copper foil. A good peel strength of 20.8 N/m was obtained.

### Example 2

A negative electrode slurry was prepared by the same operations as Example 1 except that in Step B, 1.0 part of the hydrophilic binder R-1 was mixed with 31.5 parts of deionized water and added as an aqueous solution of the hydrophilic binder in a water-swelled gel state as a Step B1, and the slurry viscosity was measured.

### Examples 3 and 5 to 14 and Comparative Examples 1 to 4

Negative electrode slurries were prepared as in Example I except that the compositions and preparation conditions of the negative electrode slurries were as shown in Table 1, and the slurry viscosities were measured.

### Example 4

A powder mixture was obtained by the same operations as Example 1, and in Step A, 43.5 parts of deionized water were added to the powder mixture to adjust the solids concentration to 69.4%, and this was kneaded for 25 minutes in a planetary mixer at 95 rpm.

Next, in Step B, 1.0 part of the hydrophilic polymer R-1 was added as a Step B2, and this was kneaded for 5 minutes in the planetary mixer at 95 rpm, after which 31.5 parts of deionized water were added as a Step B3, and this was kneaded for 20 minutes in the planetary mixer at 95 rpm.

A negative electrode slurry was then prepared with the subsequent operations being the same as Example 1, and the slurry viscosity was measured.

TABLE 1

| | | | | | Example No. | | | | | | | | |
|---|---|---|---|---|---|---|---|---|---|---|---|---|---|
| | | | | | Example | Example | Example | Example | Example | Example | Example | Example | Example |
| | | | | | 1 | 2 | 3 | 4 | 5 | 6 | 7 | 8 | 9 |
| Slurry | Dry | Active | Artificial graphite | Parts | 77.6 | 77.6 | 77.6 | 77.6 | 97.0 | 77.6 | 77.6 | 77.6 | 77.6 |
| composition | mixing | material | SiO | Parts | 19.4 | 19.4 | 19.4 | 19.4 | 0.0 | 19.4 | 19.4 | 19.4 | 19.4 |
| manufacturing | | Thickener | CMC | Parts | 1.5 | 1.5 | 1.5 | 1.5 | 1.5 | 1.5 | 1.5 | 1.5 | 1.5 |
| step | | Binder | Hydrophilic | Type | | | R-1 | | | | | | |
| | | | binder | Parts | | | 0.5 | | | | | | |
| | | Dry mixing time (minutes) | | | 7 | 7 | 7 | 7 | 7 | 7 | 7 | 7 | 7 |
| | | Planetary mixer rotation [rpm] | | | 40 | 40 | 40 | 40 | 40 | 40 | 40 | 40 | 40 |
| | Step A | Deionized water | | Parts | 43.5 | 43.5 | 43.5 | 43.5 | 43.5 | 43.5 | 43.5 | 53.0 | 40.0 |
| | | Solids concentration of composition | | | 69.4% | 69.4% | 69.5% | 69.4% | 69.4% | 69.4% | 69.4% | 65.0% | 71.1% |
| | | Kneading time (minutes) | | | 30 | 30 | 30 | 25 | 30 | 15 | 30 | 30 | 30 |
| | | Planetary mixer rotation [rpm] | | | 95 | 35 | 95 | 95 | 95 | 95 | 60 | 95 | 95 |
| | | Temperature before kneading [° C.] | | | 26.1 | 28.3 | 25.2 | 27.3 | 23.0 | 26.5 | 24.8 | 28.7 | 26.2 |
| | | Temperature after kneading [° C.] | | | 36.4 | 36.8 | 37.8 | 35.0 | 31.5 | 32.7 | 31.0 | 34.1 | 35.1 |
| | Step B | Step name | | | | | | B2 | | | | | |
| | | Binder | Hydrophilic | Type | | | | R-1 | | | | | |
| | | | binder | Parts | | | | 1.0 | | | | | |
| | | Kneading time (minutes) | | | | | | 5 | | | | | |
| | | Planetary mixer rotation [rpm] | | | | | | 95 | | | | | |
| | | Temperature before kneading [° C.] | | | | | | 34.5 | | | | | |
| | | Temperature after kneading [° C.] | | | | | | 34.9 | | | | | |
| | | Step name | | | | B1 | | B3 | | | | | |
| | | Binder | Hydrophilic | Type | R-1 | R-1 | R-1 | | R-1 | R-1 | R-1 | R-1 | R-1 |
| | | | binder | Parts | 1.0 | 1.0 | 0.5 | | 1.0 | 1.0 | 1.0 | 1.0 | 1.0 |
| | | | Deionized water | Parts | | 31.5 | | | | | | | |
| | | Deionized water | | Parts | 31.5 | | 31.5 | 31.5 | 31.5 | 31.5 | 31.5 | 22.0 | 35.0 |
| | | Solids concentration of composition | | | 57.0% | 57.0% | 57.0% | 56.8% | 57.0% | 57.0% | 57.0% | 57.0% | 57.0% |
| | | Kneading time (minutes) | | | 20 | 20 | 20 | 20 | 20 | 10 | 20 | 20 | 20 |
| | | Planetary mixer rotation [rpm] | | | 95 | 95 | 95 | 95 | 95 | 95 | 60 | 95 | 95 |
| | | Temperature before kneading [° C.] | | | 31.9 | 32.5 | 31.2 | 31.1 | 29.5 | 30.8 | 30.1 | 32.5 | 31.5 |
| | | Temperature after kneading [° C.] | | | 32.6 | 32.1 | 31.4 | 30.4 | 30.3 | 31.4 | 31.1 | 31.8 | 31.6 |
| | Step C | Binder | SBR | Parts | 1.5 | 1.5 | 1.5 | 1.5 | 1.5 | 1.5 | 1.5 | 1.5 | 1.5 |

| | | | | | | | | | |
|---|---|---|---|---|---|---|---|---|---|
| Solids concentration of composition [%] | 53.0% | 53.0% | 53.0% | 53.0% | 53.0% | 53.0% | 53.0% | 53.0% | 53.0% |
| Mixing time (minutes) | 10 | 10 | 10 | 10 | 10 | 10 | 10 | 10 | 10 |
| Planetary mixer rotation [rpm] | 95 | 95 | 95 | 95 | 95 | 95 | 60 | 95 | 95 |

| | | | | | | | | | | |
|---|---|---|---|---|---|---|---|---|---|---|
| Evaluation | Electrode slurry viscosity [mPa · s] | 8,350 | 7,830 | 10,720 | 8,410 | 5,940 | 10,520 | 10,360 | 9,120 | 8,770 |
| results | Peel strength [N/m] | 20.8 | 21.2 | 20.2 | 21.4 | 19.8 | 18.6 | 18.5 | 19.5 | 19.7 |

TABLE 2

| | | | | | Example/Comparative Example No. | | | | |
|---|---|---|---|---|---|---|---|---|---|
| | | | | | Example | Example | Example | Example | Example |
| | | | | | 10 | 11 | 12 | 13 | 14 |
| Slurry | Dry | Active | Artificial graphite | Parts | 77.8 | 77.6 | 77.6 | 77.6 | 77.6 |
| composition | mixing | material | SiO | Parts | 19.4 | 19.4 | 19.4 | 19.4 | 19.4 |
| manufacturing | | Thickener | CMC | Parts | 1.5 | 1.5 | 1.5 | 1.5 | 1.5 |
| step | | Binder | Hydrophilic | Type | | | | | |
| | | | binder | Parts | | | | | |
| | | Dry mixing time (minutes) | | | 7 | 7 | 1 | 7 | 7 |
| | | Planetary mixer rotation [rpm] | | | 40 | 40 | 40 | 40 | 40 |
| | Step A | Deionized water | | Parts | 43.5 | 43.5 | 43.5 | 43.5 | 43.5 |
| | | Solids concentration of composition | | | 69.4% | 69.4% | 69.4% | 69.4% | 69.4% |
| | | Kneading time (minutes) | | | 30 | 30 | 30 | 30 | 30 |
| | | Planetary mixer rotation [rpm] | | | 95 | 95 | 95 | 95 | 95 |
| | | Temperature before kneading [° C.] | | | 24.5 | 25.6 | 26.0 | 29.5 | 24.5 |
| | | Temperature after kneading [° C.] | | | 35.9 | 36.0 | 32.3 | 35.5 | 33.2 |
| | Step B | Binder | Hydrophilic | Type | R-1 | R-1 | R-2 | R-3 | R-4 |
| | | | binder | Parts | 0.5 | 1.5 | 1.0 | 1.0 | 1.0 |
| | | Deionized water | | Parts | 31.5 | 31.5 | 31.5 | 31.5 | 31.5 |
| | | Solids concentration of composition | | | 56.9% | 57.1% | 57.0% | 57.0% | 57.0% |
| | | Kneading time (minutes) | | | 20 | 20 | 20 | 20 | 20 |
| | | Planetary mixer rotation [rpm] | | | 95 | 95 | 95 | 95 | 95 |
| | | Temperature before kneading [° C.] | | | 29.8 | 31.3 | 29.1 | 31.2 | 31.2 |
| | | Temperature after kneading [° C.] | | | 30.2 | 32.1 | 29.0 | 30.7 | 30.8 |
| | Step C | Binder | SBR | Parts | 1.5 | 1.5 | 1.5 | 1.5 | 1.5 |

| | | | | | |
|---|---|---|---|---|---|
| Solids concentration of composition [%] | 53.0% | 53.0% | 53.0% | 53.0% | 53.0% |
| Mixing time (minutes) | 10 | 10 | 10 | 10 | 10 |
| Planetary mixer rotation [rpm] | 95 | 95 | 95 | 95 | 95 |

| | | | | | | |
|---|---|---|---|---|---|---|
| Evaluation | Electrode slurry viscosity [mPa · s] | 6,890 | 10,920 | 6,720 | 2,050 | 2,240 |
| results | Peel strength [N/m] | 19.0 | 22.8 | 22.6 | 18.0 | 17.4 |

| | | | | | Example/Comparative Example No. | | | |
|---|---|---|---|---|---|---|---|---|
| | | | | | Comparative | Comparative | Comparative | Comparative |
| | | | | | Example | Example | Example | Example |
| | | | | | 1 | 2 | 3 | 4 |
| Slurry | Dry | Active | Artificial graphite | Parts | 77.0 | 77.6 | 77.6 | 77.6 |
| composition | mixing | material | SiO | Parts | 19.4 | 19.4 | 19.4 | 19.4 |
| manufacturing | | Thickener | CMC | Parts | 1.5 | 1.5 | 1.5 | 1.5 |
| step | | Binder | Hydrophilic | Type | R-1 | R-2 | R-3 | R-4 |
| | | | binder | Parts | 1.0 | 1.0 | 1.0 | 1.0 |
| | | Dry mixing time (minutes) | | | 7 | 7 | 7 | 7 |
| | | Planetary mixer rotation [rpm] | | | 40 | 40 | 40 | 40 |
| | Step A | Deionized water | | Parts | 43.5 | 43.5 | 43.5 | 43.5 |
| | | Solids concentration of composition | | | 69.6% | 89.6% | 69.8% | 69.8% |
| | | Kneading time (minutes) | | | 30 | 30 | 30 | 30 |
| | | Planetary mixer rotation [rpm] | | | 95 | 95 | 95 | 95 |
| | | Temperature before kneading [° C.] | | | 26.0 | 26.2 | 23.3 | 24.2 |
| | | Temperature after kneading [° C.] | | | 29.4 | 28.5 | 26.3 | 27.1 |
| | Step B | Binder | Hydrophilic | Type | | | | |
| | | | binder | Parts | | | | |
| | | Deionized water | | Parts | 31.5 | 31.5 | 31.5 | 31.5 |
| | | Solids concentration of composition | | | 57.0% | 57.0% | 57.0% | 57.0% |
| | | Kneading time (minutes) | | | 20 | 20 | 20 | 20 |
| | | Planetary mixer rotation [rpm] | | | 95 | 95 | 95 | 95 |
| | | Temperature before kneading [° C.] | | | 27.4 | 28.0 | 25.8 | 26.4 |
| | | Temperature after kneading [° C.] | | | 28.7 | 28.4 | 28.5 | 27.9 |
| | Step C | Binder | SBR | Parts | 1.5 | 1.5 | 1.5 | 1.5 |

| | | | | |
|---|---|---|---|---|
| Solids concentration of composition [%] | 53.0% | 53.0% | 53.0% | 53.0% |
| Mixing time (minutes) | 10 | 10 | 10 | 10 |
| Planetary mixer rotation [rpm] | 95 | 95 | 95 | 95 |

| | | | | | |
|---|---|---|---|---|---|
| Evaluation | Electrode slurry viscosity [mPa · s] | 25,830 | 15,230 | 40,810 | 19,370 |
| results | Peel strength [N/m] | 20.1 | 21.3 | 17.8 | 17.2 |

The details of the compounds used in Tables 1 and 2 are shown below
SiO. Silicon monoxide (Osaka Titanium Technologies, particle size 5 microns)
CMC: Carboxymethyl cellulose sodium
SBR: Styrene butadiene rubber

### Evaluation Results

As shown in Examples 1 to 14, when a composition containing a thickener was first kneaded and part or all of a hydrophilic binder was then added, productivity was excellent because the electrode slurry viscosity could be reduced even when the final solids concentration of the negative electrode slurry was high, and peel strength and adhesiveness were excellent. The reason why the viscosity of the electrode slurry was reduced with the manufacturing method of the invention is thought to be that delaying addition of the hydrophilic binder caused the thickener to be adsorbed by the active material in preference to the hydrophilic binder, so less of the thickener was present in a free form in the medium.

By contrast, when the entire amounts of the thickener and hydrophilic binder were added before kneading (Comparative Examples 1 to 4), the electrode slurry viscosities increased much more than in the examples, and productivity was inferior. This is thought to be because the hydrophilic binder and thickener were adsorbed competitively by the active material, so that more of the thickener was present in a free form in the medium.

Comparing the effects of adding part of the hydrophilic binder when dry mixing the active material and the thickener, the electrode slurry viscosity was lower without a step of adding part of the hydrophilic binder (Example 1) than with a step of adding part of the hydrophilic binder during dry mixing (Example 3). This is thought to be because while adsorption of the thickener on the active material was adequate in the first case, in the second case the part of the hydrophilic binder added during dry mixing inhibited adsorption of the thickener by the active material in the first kneading step.

Comparing the effects of kneading time in Step A, the viscosity of the resulting electrode slurry was lower when the kneading time was longer (Example 1: 30 minutes) than when the kneading time was short (Example 6: 15 minutes) in Step A. This is thought to be because in Step A the longer kneading time promoted thorough adsorption of the thickener by the active material, resulting in a lower electrode slurry viscosity.

Moreover, comparing the effects of the solid concentration of the composition in the kneading step in Step A, the viscosity of the resulting electrode slurry was lower in Example 1 (69.4%) than in Example 8 (65.0%) and Example 9 (71.1%). This is thought to be because, in Example 1, stronger shear force was applied to the composition in the kneading step in Step A, promoting thorough adsorption of the thickener by the active material and resulting in a lower electrode slurry viscosity.

### Industrial Applicability

Because a secondary battery electrode slurry composition obtained by the manufacturing method of the present invention exhibits excellent peel strength (adhesiveness) while ensuring coating properties due to the low viscosity of the slurry composition even when the solids concentration is higher than in the past, it is expected to have good durability (cycle characteristics). Consequently, a secondary battery provided with an electrode obtained using this slurry composition is expected to ensure good integrity and exhibit good durability (cycle characteristics) even after repeated charge and discharge, should contribute to higher capacities in secondary batteries for automotive use and the like, and will be useful especially in non-aqueous electrolyte secondary battery electrodes, and particularly in non-aqueous electrolyte lithium-ion secondary batteries with high energy densities.

1. A method for manufacturing a secondary battery electrode slurry composition, the method comprising:
kneading a composition having a solids concentration of equal to or not less than 60 mass % and equal to or not more than 80 mass % containing an active material, a thickener and water to obtain a first kneaded product;
adding a hydrophilic binder (different from the thickener) and water to the first kneaded product, and kneading the same to obtain a second kneaded product; and
adjusting the solids concentration of the second kneaded product to equal to or not less than 40 mass % and equal to or not more than 60 mass %.

2. The method for manufacturing a secondary battery electrode slurry composition according to claim 1, wherein the adding includes adding an aqueous solution of the hydrophilic binder to the first kneaded product, and kneading the same to obtain a second kneaded product.

3. The method for manufacturing a secondary battery electrode slurry composition according to claim 1, wherein the adding includes adding the hydrophilic binder to the first kneaded product, and kneading the same, and further adding water and kneading the same to obtain a second kneaded product.

4. The method for manufacturing a secondary battery electrode slurry composition according to claim 1, wherein the hydrophilic binder is obtained by polymerizing monomer components including an ethylenically unsaturated carboxylic acid monomer, and the ethylenically unsaturated carboxylic acid monomer constitutes equal to or not less than 50 mass % and equal to or not more than 100 mass % of total monomer components.

5. The method for manufacturing a secondary battery electrode slurry composition according to claim 1, wherein the hydrophilic binder is crosslinked with a crosslinkable monomer, and an amount of the crosslinkable monomer used is equal to or not less than 0.001 mol % and equal to or not more than 2.5 mol % of a total of a non-crosslinkable monomer.

6. The method for manufacturing a secondary battery electrode slurry composition according to claim 1, wherein the hydrophilic binder has a degree of neutralization of equal to or not less than 80 mol % and equal to or not more than 100 mol %.

7. The method for manufacturing a secondary battery electrode slurry composition according to claim 1, wherein the thickener contains carboxymethyl cellulose (CMC).

8. The method for manufacturing a secondary battery electrode slurry composition according to claim 1, wherein the adjusting includes adding styrene-butadiene rubber (SBR) latex.

9. A method for manufacturing a secondary battery electrode, the method comprising forming on a surface of a collector a mixture layer from a secondary battery electrode slurry composition obtained by a secondary battery electrode slurry composition manufacturing method according to claim 1.

10. A method for manufacturing a secondary battery, the method comprising a manufacturing a secondary battery provided with the secondary battery electrode obtained by the manufacturing method according to claim 9.
